(19) United States
(12) Patent Application Publication
(10) Pub. No.: US 2008/0095894 A1
(43) Pub. Date: Apr. 24, 2008

(54) PROCESS FOR PREPARING ROAST CHICKEN RILLETTES

(75) Inventor: Andre CORMIER, Coulaines (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Luissier, Viroflay (FR)

(21) Appl. No.: 11/551,938

(22) Filed: Oct. 23, 2006

(51) Int. Cl. A23L 1/31

(52) U.S. Cl. 426/92

(57) ABSTRACT

Process for preparing rillettes, from a browned meat of a first poultry, a roasted and cut skin of a second poultry, this process comprising mixing, browning and cooking the ingredients.

The subject of the invention is a novel process for preparing a spreadable food product of the rillette type, this product being characterized by a novel flavor and taste.

Traditionally, rillettes are manufactured from the meat of pig or sow to which salt and pepper are added. The meats are browned and cooked slowly in their fat in order to obtain fibers and the flavor of rillettes.

Other types of rillettes are known, such as poultry (chicken, turkey, goose, duck), rabbit and game rillettes.

From a dietetic point of view, rillettes have the reputation of being a fatty product. That is why rillettes less rich in fat, in particular rillettes obtained from poultry meat, are liked by consumers concerned about having a diet with a lower fat content.

Efforts have therefore been made to develop a process for manufacturing rillettes based on poultry meat, and in particular chicken meat, which lead to a perfumed product whose flavor resembles that of roast chicken, or of another roast poultry.

The process is characterized in particular in that in addition to meat, a chicken skin or the skin of another poultry that has undergone a specific preparation process is used.

The use of poultry skin in the preparation of rillettes is known in particular from the “code des usages de la charcuterie [code of prepared meat product uses]”.

However, the incorporation of raw chicken skin leads to rillettes whose taste is too bland to satisfy the consumer.

Various documents describe food products obtained from chicken skins:

Several documents relate to reconstituted chicken or poultry meats. The meats are precooked, combined with the aid of a binder which may be made based on chicken skin (GB-1293449; GB-1257696; GB-1,189,670; GB-1,127,718; GB-1118694; GB-1041497).

According to EP-0951843 and GB-2269083, frozen chicken meats are reduced to chips and mixed with chicken skins that are also in the form of chips. The whole is mixed, shaped and cooked.

U.S. Pat. No. 5,786,015 describes a process for producing a food product based on chicken with a high protein level. Chicken pieces (flesh and skin) are cooked in oil and pressed in order to extract the oil therefrom.

GB-2087210 describes a product obtained from poultry skins. The skins cut into pieces are boiled, cooled at low temperature and ground. Such particles are used for the preparation of flavoring agents intended to confer a meat-like taste on foods.

U.S. Pat. No. 3,704,135 describes a process for reconstituting a chicken or poultry skin from a ground chicken or poultry skin.

An emulsion of skin is prepared and shaped and then cooked. Artificial skins with a large format can thus be obtained; they are intended for coating poultry meats.

US-2004/0067291 describes a crunchy product to be eaten as a snack, obtained by frying pieces of chicken skins. These chicken skins may have been macerated beforehand in a sauce such as a sweet and sour sauce.

However, none of these documents relates to the preparation of rillettes and none of these documents discloses the specific process which is the subject of the present invention.

The subject of the invention is a process for preparing a spreadable food product, such as rillettes, this process being characterized in that:
(i) a meat of a first poultry is browned in a pot in animal fat;
(ii) a skin of a second raw poultry is roasted and cut up;
(iii) the skin obtained from step (ii) is added to the pot in which the meat of the first poultry is being cooked;
(iv) the whole is mixed and browned;
(v) the whole is cooked;
(vi) after a final mixing, the product is packaged.

Optionally, step (ii) may be preceded by a step (ia) in which the skin of the second poultry is macerated in a mixture comprising honey or sugar, and vinegar.

Unlike the prior art processes, the process of the invention leads to a product with an enhanced roast poultry taste capable of satisfying the consumer.

The first poultry whose meat is extracted in order to produce the rillettes according to the process disclosed above are chosen in particular from: chicken, turkey, goose, duck, game. Preferably, chicken is chosen. According to one variant, the meat of the first poultry may be replaced with rabbit.

The meat may be obtained from any part of the poultry chosen for the preparation.

This meat is browned in a pot in animal fat, preferably goose fat or duck fat is chosen. It is also possible to use a mixture of goose or duck fat with pig fat. For this step, the meat may be gradually incorporated.

Browning is a heat treatment with coloring extending to surface caramelization of the meat obtained using a fat heated in order to sear it. Browning occurs in a significant quantity of fat, the meat is constantly mixed so as to obtain coloring that is well distributed over the whole of the meat.

The pot is of the appropriate size for the volume of product to be prepared.

The meat of the first poultry is incorporated into the animal fat and browned.

In step (ii), the skin of a second poultry is prepared in parallel or prior to step (i).

The second poultry may be chicken, turkey, goose, duck or game. According to the process of the invention, chicken skin is preferably used.

According to a preferred variant of the invention, the first and second poultry are identical.

According to a preferred variant of the invention, the raw poultry skin, obtained in a manner known to a person skilled in the art, is left to macerate in a mixture comprising sugar or honey, and vinegar.

Preferably, the mixture of skin and marinade comprises by weight:
1 to 20% of vinegar
2 to 30% of honey or sugar
50 to 97% of poultry skin.

Preferably, honey and vinegar which may be of any origin or of any type are used. Other constituents may be used in the marinade and in particular spices, aromatic plants, flavorings, wines, alcohols, flavor preparations.

The marinade is prepared by simply mixing its constituents in the cold or hot state. The maceration time is 30 minutes to 24 hours. The maceration is performed at a temperature ranging from 0 to 4° C.

The macerated skin is optionally drained, and then roasted by exposure to a source of heat at a temperature ranging from 180° C. to 500° C. However, it is possible to use a raw skin directly and to roast it without a maceration step.

The appliance used for roasting consists of racks: gas, electric, infrared.

The roasted skin may be cooled and then cut into pieces. According to a variant of the invention, the skin may be cut up before the maceration or before the roasting.

It may be used directly in the process by incorporating it into the mixture of step (i). According to a variant of the invention, it may be packaged so as to be stored for a deferred use, optionally pasteurized, frozen.

The roasted skin of the second poultry is incorporated into the pot as a supplement to the meat of the first poultry.

The proportion of meat of the first poultry and of roast skin of the second poultry, optionally macerated, in the pot in step (iii) is 3 to 20% of skin, by weight relative to the weight of the meat.

The whole, consisting of the first poultry and of the second poultry, is browned.

The total browning time (steps (i) and (iv)) varies from 1 hour to 2 hours at a temperature of 80° C. to 120° C., preferably 100 to 110° C. For the browning step, the temperature indicated is that of the walls of the pot in which this step is performed. The whole mixture does not simultaneously reach this temperature.

In step (v), the cooking in the pot lasts for 2 hours to 5 hours, at a temperature of 85° C. to 110° C., preferably 90 to 95° C. In this step, the cooking is performed without stirring, slowly, the meat being covered with fat (the fat incorporated in step (i) and the fat released by the meat in the preceding steps). The whole of the mixture is appreciably at the same temperature. According to a variant of the invention, the cooking in step (v) may be performed under pressure.

At the end, the mixture is homogenized, measured out and packaged. The packaging is suitable to the mode of marketing: for cutting or in individual pots.

Other constituents, additives or flavorings known to a person skilled in the art may be introduced in any of the steps above. There may be mentioned in particular salt, aromatic herbs, spices, caramel, wines, alcohols and the like.

### EXAMPLE

50 kg of duck fat are introduced, in the cold state, into a 360 L cooker. The pot is brought to 80° C.

200 kg of chicken meat obtained from the drumstick are introduced into the molten fat.

The whole is mixed with the aid of a mechanical stirrer and browned between 100 and 120° C. for 35 minutes.

In parallel, the roast chicken skin is prepared from 60 kg of raw chicken skin, which are introduced into a mixture of 3 l of wine vinegar and 6 kg of honey. The combination of skin and marinade is blended and the skins are placed on the rack of a roaster and cooked for 15 minutes at 270° C. The roast skins are cooled and cut into pieces with the aid of a blade.

The skin pieces are introduced into the cooker as well as flavorings, carrots, salt, pepper. The whole is mixed for 15 minutes and then browned for 2 hours without a cover.

Cooking takes place for 2 hours at 100° C.

The cooker is then opened, the mixture is homogenized with the aid of a mechanical stirrer and transferred into 220 g containers which are sealed and stored at cold temperature (0 to 4° C.).

1. A process for preparing a spreadable food product, such as rillettes, this process being characterized in that:
(i) a meat of a first poultry is browned in a pot in animal fat;
(ii) a skin of a second raw poultry is roasted and cut up;
(iii) the skin obtained from step (ii) is added to the pot in which the meat of the first poultry is being cooked;
(iv) the whole is mixed and browned;
(v) the whole is cooked;
(vi) after a final mixing, the product is packaged.

2. The process as claimed in claim 1, characterized in that step (ii) is preceded by a step (ia) in which the skin of the second poultry is macerated in a mixture comprising honey or sugar, and vinegar.

3. The process as claimed in claim 1 or claim 2, characterized in that the first poultry is chosen from: chicken, turkey, goose, duck, game, preferably chicken.

4. The process as claimed in claim 1 or claim 2, characterized in that the meat of the first poultry is replaced with rabbit.

5. The process as claimed in any one of claims 1 to 4, characterized in that the animal fat is chosen from goose fat and duck fat.

6. The process as claimed in any one of claims 1 to 5, characterized in that the second poultry is chosen from chicken, turkey, goose, duck or game, preferably chicken.

7. The process as claimed in any one of claims 2 to 6, characterized in that the whole consisting of the skin and the marinade in step (ia) comprises by weight 1 to 20% of vinegar, 2 to 30% of honey or sugar, and 50 to 97% of poultry skin.

8. The process as claimed in any one of claims 2 to 6, characterized in that the maceration is performed between 0 and 4° C. for a period of 30 minutes to 24 hours.

9. The process as claimed in any one of claims 1 to 8, characterized in that the roasting in step (ii) is performed at a temperature ranging from 180 to 500° C.

10. The process as claimed in any one of claims 1 to 9, characterized in that the proportion of meat of the first poultry and of roast skin of the second poultry and macerated in step (iii) is from 3 to 20% by weight of skin relative to the weight of the meat.

11. The process as claimed in any one of claims 1 to 10, characterized in that the total browning time is from 1 to 2 hours at a temperature of 80 to 120° C., preferably from 100 to 110° C.

12. The process as claimed in any one of claims 1 to 11, characterized in that in step (v), the combination consisting of the poultry flesh and of the roast macerated skin is cooked in a pot for a period of 2 to 5 hours, at a temperature of 85 to 110° C., preferably 100 to 110° C.
